(19) United States
(12) Patent Application Publication
(10) Pub. No.: US 2025/0372299 A1
(43) Pub. Date: Dec. 4, 2025

(54) MANUFACTURING METHOD OF COMPOSITE-TYPE MICRO-INDUCTOR

(71) Applicant: Phoenix Pioneer Technology Co., Ltd., Hsinchu County (TW)

(72) Inventors: PAO-HUNG CHOU, Hsinchu County (TW); MING-YEH CHANG, Hsinchu County (TW)

(21) Appl. No.: 19/215,135

(22) Filed: May 21, 2025

(30) Foreign Application Priority Data
May 29, 2024 (TW) 113119862

(51) Int. Cl. H01F 41/04

(52) U.S. Cl. CPC H01F 41/041

(57) ABSTRACT

The present invention discloses a manufacturing method of a composite-type micro-inductor, including following steps. A first step involves providing a first substrate, which includes a first dielectric layer and a magnetic assembly. The magnetic assembly is disposed on the first dielectric layer. A second step involves providing a second substrate, which includes a second dielectric layer, a patterned circuit layer, and an opening. The patterned circuit layer is stacked in a plurality of layers, and the opening penetrate the second dielectric layer. At least a part of the patterned circuit layer is embedded in the second dielectric layer. A third step involves placing the second substrate on the first substrate by threading the magnetic assembly through the opening. A fourth step involves covering the first substrate and the second substrate with a third dielectric layer, and finally forming the composite-type micro-inductor.

### CROSS-REFERENCE TO RELATED APPLICATION

This application claims the priority benefit of Taiwan application (Application No. 113119862), filed on May 29, 2024. The entirety of the above-mentioned patent application is hereby incorporated by reference herein and made a part of this specification.

### FIELD OF THE INVENTION

The present invention relates to a manufacturing method of an inductor, in particular to a manufacturing method of a composite-type micro-inductor.

### BACKGROUND OF THE INVENTION

In electronic circuits, inductors, also known as coils, are common components used to suppress power supply noise, and are usually made of a wire wound around a magnetic core. Since an efficiency of an inductor is related to a number of turns wound in the wire and a cross-sectional area of the wire, volume of the inductor will thus increase as the number of turns increases. As a result, the inductors have always been one of the most difficult electronic components to be miniaturized, which therefore is an important research and development goal in nowadays electronic devices that pay particular attention to features of thin and light.

For this reason, multilayer inductors and thin-film inductors have been developed as solutions for miniaturizing inductors in current industry. Among them, the multilayer inductor is tied to one of thin sheets of a magnetic core material, and a coil circuit is printed by screen printing. The multi-layer thin sheets of the screen-printing coil are stacked in layers and then laminated, cut into size of an inductor component, and made by debinding and sintering, and forming electrodes on both ends of the inductor components. In addition, as a conductor of a winding pattern, a thin film inductor is made by using sputtering or deposition technique on a substrate to form a thinner metal film than a thin film inductor made by printing, and finally the manufacturing processes are completed by coating the thinner metal film with an insulating layer.

However, in addition to technical limitations of miniaturization, the conventional approaches also limited by fact that specifications of the core and coil of the inductor cannot be changed in the same manufacturing processes, such as increasing or decreasing a number of the coil circuits. If different coils and cores are required to form inductors with different inductance values, a separate manufacturing process line must be created.

Therefore, inventors are eager to find a manufacturing method of a composite-type micro-inductor to improve the above-mentioned problems.

### SUMMARY OF THE INVENTION

In a view of the above description, one of the purposes of the present invention is to provide a micro, high-precision micro inductor through semiconductor manufacturing technology. On the other hand, another object of the present invention is to provide a manufacturing method of a composition-type inductor so that various components of the inductor can be flexibly matched to form a suitable inductor.

In order to achieve the above purposes, the manufacturing method of the composite-type micro-inductor of the present invention includes following steps. Step 1 involves providing a first substrate, having a first temporary carrier plate, a first dielectric layer, and a magnetic assembly, wherein the first dielectric layer is formed on a surface of the first temporary carrier plate, and the magnetic assembly is disposed on the first dielectric layer. Step 2 involves providing a second substrate, having a second dielectric layer, a second patterned circuit layer stacked in a plurality of layers, and an opening penetrating through the second dielectric layer, wherein at least a part of the second patterned circuit layer is embedded in the second dielectric layer, a part of the second patterned circuit layer constitutes an inductor coil, a part of the second patterned circuit layer constitutes a conductive circuit and/or a plurality of electrodes, and a central area of the inductor coil overlaps with the opening. Step 3 involves using the first substrate as a carrier and disposing the second substrate on the first substrate in a way similar to the magnetic assembly of the first substrate is threaded through and disposed in the opening of the second substrate. Step 4 involves forming a third dielectric layer to cover the first substrate and the second substrate filling the opening with the third dielectric layer, wherein the magnetic assembly is embedded in the third dielectric layer, and the first substrate and the second substrate combined as a whole. Step 5 involves performing a leveling process to remove a part of the third dielectric layer, thereby exposing a part of a surface of the second patterned circuit layer. Step 6 involves removing the first temporary carrier plate of the first substrate to form an inductor structure.

In addition, in order to achieve the above purposes, another manufacturing method of a composite-type micro-inductor of the present invention includes the following steps. Step 1 involves providing a first substrate, having a first temporary carrier plate, a first dielectric layer, and a magnetic assembly, wherein the first dielectric layer is formed on a surface of the first temporary carrier plate, and the magnetic assembly is disposed on the first dielectric layer. Step 2 involves providing a second substrate, having a second temporary carrier plate, a second dielectric layer disposing on the second temporary carrier plate, and a second patterned circuit layer stacked in a plurality of layers, wherein a part of a structure of the second patterned circuit layer is embedded in the second dielectric layer, a part of the second patterned circuit layer constitutes a second conductive circuit and/or a plurality of second electrodes, a part of the second patterned circuit layer constitutes a second inductive circuit, and a part of the second inductive circuit is not wrapped by the second dielectric layer. Step 3 involves using the second substrate as a carrier and sequentially stacking and covering an insulating film and the first substrate onto the second substrate for lamination, wherein the magnetic assembly of the first substrate is embedded in an area framed by the second inductive circuit, the magnetic assembly and the second inductive circuit do not electrically connect to each other, the insulating film is filled between the first dielectric layer and the second dielectric layer, the magnetic assembly is embedded in the insulating film, and the first substrate and the second substrate combined as a whole. Step 4 involves removing the first temporary carrier plate to expose a surface of the first dielectric layer. Step 5 involves removing a part of the first dielectric layer to form a plurality of blind holes, thereby exposing a part of a surface of the second patterned circuit layer. Step 6 involves forming a third substrate on the first dielectric layer by a build-up layer circuit process, wherein the third substrate includes a third dielectric layer and a third patterned circuit layer stacked in a plurality of layers and embedded in the third dielectric layer, a part of the third patterned circuit layer constitutes a third inductive circuit electrically connected to the second patterned circuit layer, the third patterned circuit layer combines with the second inductive circuit of the second patterned circuit layer to constitute a complete inductor coil, a part of the third patterned circuit layer constitutes a third conductive circuit and/or a plurality of third electrodes, and a part of a surface of the third patterned circuit layer is exposed on a surface of an upper side of the third dielectric layer. Step 7 involves removing the second temporary carrier plate of the second substrate to form an inductor structure.

In one embodiment, the second inductive circuit includes a plurality of conductive columns, the conductive columns are not wrapped by the second dielectric layer, and an area framed by the conductive columns can accommodate the magnetic assembly.

Furthermore, in order to achieve the above purposes, a manufacturing method of a composite-type micro-inductor of the present invention includes the following steps. Step 1 involves providing a first substrate, having a first temporary carrier plate, a first dielectric layer, and a magnetic assembly, wherein the first dielectric layer is formed on a surface of the first temporary carrier plate, and the magnetic assembly is disposed on the first dielectric layer. Step 2 involves providing a second substrate, having a second temporary carrier plate, a second dielectric layer having an opening and disposing on the second temporary carrier plate, and a second patterned circuit layer stacked in a plurality of layers, wherein a part of a structure of the second patterned circuit layer is embedded in the second dielectric layer, a part of the second patterned circuit layer constitutes a second conductive circuit and/or a plurality of second electrodes, a part of the second patterned circuit layer constitutes a second inductive circuit, and an area that frames by the second inductive circuit overlaps with the opening. Step 3 involves using the second substrate as a carrier and sequentially stacking and covering an insulating film and the first substrate onto the second substrate for lamination, wherein the magnetic assembly of the first substrate is embedded in the opening and does not electrically connect to the second inductive circuit, the insulating film is filled between the first dielectric layer and the second dielectric layer and in the opening, the magnetic assembly is embedded in the insulating film, and the first substrate and the second substrate combined as a whole. Step 4 involves removing the first temporary carrier plate to expose a surface of the first dielectric layer. Step 5 involves removing a part of the first dielectric layer to form a plurality of blind holes, thereby exposing a part of a surface of the second inductive circuit. Step 6 involves forming a third substrate on the first dielectric layer by the build-up layer circuit process, wherein the third substrate includes a third dielectric layer and a third patterned circuit layer stacked in a plurality of layers and embedded in the third dielectric layer, a part of the third patterned circuit layer constitutes a third inductive circuit electrically connected to the second inductive circuit, the third patterned circuit layer combines with the second inductive circuit to constitute a complete inductor coil, a part of the third patterned circuit layer constitutes a third conductive circuit and/or a plurality of third electrodes, and a part of a surface of the third patterned circuit layer is exposed on a surface of an upper side of the third dielectric layer. Step 7 involves removing the second temporary carrier plate of the second substrate to form an inductor structure.

In one embodiment, the magnetic assembly includes at least one magnetic component in a form of a block, an array column, a sheet, a fin, or a grid.

In one embodiment, the inductor coil includes an annular solenoid coil, a solenoid coil, or a multi-layer planar spiral coil.

As mentioned above, the manufacturing method of the composite-type micro-inductor of the present invention is to separately manufacture the first substrate as the magnetic core part of the inductor and the second substrate as the coil part, and then combine the first substrate and second substrate to form the composite-type micro-inductor.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The present invention will become more readily apparent to those ordinarily skilled in the art after reviewing the following detailed description and accompanying drawings, in which:

FIG. 1A to FIG. 1G are schematic structural diagrams showing a manufacturing method of a composite-type micro-inductor according to a first preferred embodiment of the present invention;

FIG. 2 is a schematic structural diagram showing a composite-type micro-inductor with a second type of a magnetic assembly according to an embodiment of the present invention;

FIG. 3 is a schematic structural diagram showing a composite-type micro-inductor with a third type of a magnetic assembly according to an embodiment of the present invention;

FIG. 4 is a schematic structural diagram showing a composite-type micro-inductor with a fourth type of a magnetic assembly according to an embodiment of the present invention;

FIG. 5A and FIG. 5B are schematic structural diagrams showing a composite-type micro-inductor with a fifth type of a magnetic assembly according to an embodiment of the present invention, wherein FIG. 5A is a schematic cross-sectional view, and FIG. 5B is a top view of the magnetic component of FIG. 5A;

FIG. 6A and FIG. 6B are schematic structural diagrams showing a composite-type micro-inductor with a sixth type of a magnetic assembly according to an embodiment of the present invention, wherein FIG. 6A is a schematic cross-sectional view, and FIG. 6B is a top view of the magnetic component of FIG. 6A;

FIG. 7A to FIG. 7H are schematic structural diagrams showing a manufacturing method of a composite-type micro-inductor according to a second preferred embodiment of the present invention; and

FIG. 8A and FIG. 8B are schematic structural diagrams showing a part of a manufacturing method of a composite-type micro-inductor according to a third preferred embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

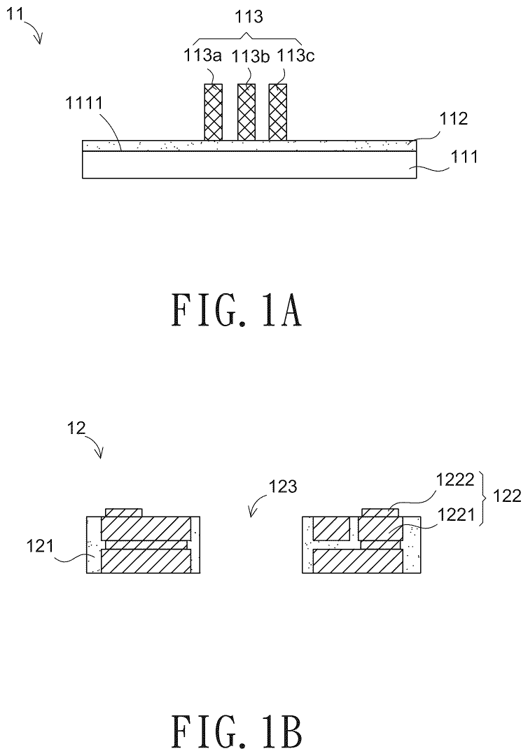

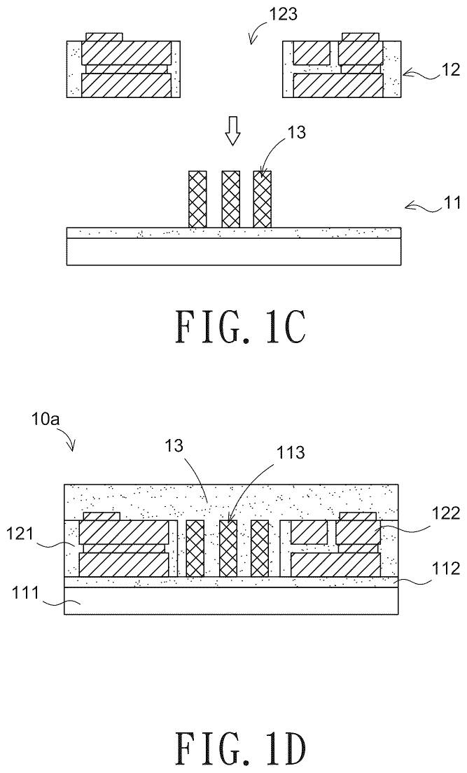

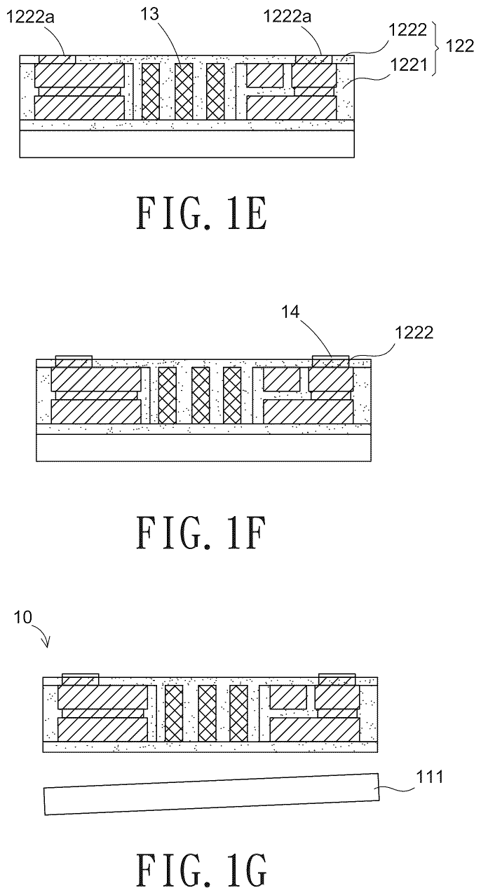

FIG. 1A to FIG. 1G are schematic structural diagrams showing a manufacturing method of a composite-type micro-inductor 10 according to the first preferred embodiment of the present invention. The manufacturing method of the composite-type micro-inductor 10 includes steps S01 to S07. It should be noted that the steps described in the present embodiment are not limited to their order, except for those specifically describing steps with a specific relationship of order.

As shown in FIG. 1A, step S01 is to provide a first substrate 11, which includes a first temporary carrier plate 111, a first dielectric layer 112, and a magnetic assembly 113. The first dielectric layer 112 is formed and covers a surface 1111 of the first temporary carrier plate 111. The magnetic assembly 113 is disposed on the first dielectric layer 112. The magnetic assembly 113 of the present embodiment includes three columnar magnetic components 113a, 113b, and 113c, which are upright disposed on the first dielectric layer 112.

The first substrate 11 can be manufactured through a carrier board manufacturing process. For example, the manufacturing process can include: forming the first dielectric layer 112 on the first temporary carrier plate 111, forming three openings on the first dielectric layer 112, forming the magnetic assembly 113 in the openings, and finally removing a part of the first dielectric layer 112 to expose the magnetic assembly 113. In some embodiments, the opening can be formed by laser drilling or mechanical drilling. In some embodiments, the magnetic assembly 113 can be formed by an electroplating technique, and materials of the magnetic assembly 113 include but are not limited to alloy metals with high magnetic permeability such as nickel (Ni), nickel-iron alloy (NiFe), and cobalt-nickel-iron alloy (CoNiFe).

As shown in FIG. 1B, step S02 is to provide a second substrate 12, which includes a second dielectric layer 121, a second patterned circuit layer 122, and an opening 123. A part of the second patterned circuit layer 122 is embedded in the second dielectric layer 121. In the present embodiment, the part of the second patterned circuit layer 122 embedded in the second dielectric layer 121 serves as an inductor coil 1221, and a part of the second patterned circuit layer 122 exposed on the second dielectric layer 121 serves as an electrode 1222, but the present invention is not limited thereto. For example, the part of the second patterned circuit layer 122 can also serve as a conductive circuit. A central area of the inductor coil 1221 substantially overlaps with the opening 123, and the opening 123 penetrates through the second dielectric layer 121. In addition, in the present embodiment, the inductor coil 1221 can include a solenoid coil or a multi-layer planar spiral coil.

As illustrated further herein, the second dielectric layer 121 and the second patterned circuit layer 122 can be formed layer by layer through the carrier board manufacturing process. For example, a sub-dielectric layer is formed on a second temporary carrier plate. After forming a patterned opening on the sub-dielectric layer, conductive metal is electroplated in the patterned opening. Then, the above-mentioned steps of forming the sub-dielectric layer, forming the patterned opening, and electroplating the conductive metal to form the second dielectric layer 121 and the second patterned circuit layer 122 in a manner of layer by layer is repeated. Finally, the second temporary carrier plate is removed to form the second substrate 12. A material of the stacked second patterned circuit layer 122 is, for example but not limited to, copper, and can have low resistance after the stack of layers is thickened.

As shown in FIG. 1C, step S03 is to use the first substrate 11 as a carrier, and the second substrate 12 is disposed on the first substrate 11. The magnetic assembly 113 of the first substrate 11 is threaded through and disposed in the opening 123 of the second substrate 12.

As shown in FIG. 1D, step S04 is to form a third dielectric layer 13 to cover the first substrate 11 and the second substrate 12, and the third dielectric layer 13 fills the opening 123. Further, the magnetic assembly 113 is embedded in the third dielectric layer 13, and the first substrate 11 and the second substrate 12 combined as a whole to form a semi-finished inductor 10a.

As shown in FIG. 1E, step S05 is to perform a leveling process, which is, for example, ground the third dielectric layer 13 to expose an upper surface 1222a of the second patterned circuit layer 122 that serves as a part of the terminal electrode 1222. In other embodiments, the leveling process can also be completed by etching.

As shown in FIG. 1F, step S06 is to form a bonding protective layer 14 on the exposed electrode 1222. In the present embodiment, the bonding protective layer 14 can protect the electrode 1222 from oxidative deterioration and also have a function of being easily combined with other metals. A material of the bonding protective layer 14 is, for example but not limited to, nickel gold (NiAu), nickel palladium gold (NiPdAu), or tin, and the bonding protective layer 14 can be formed by electroplating.

Finally, as shown in FIG. 1G, step S07 is to remove the first temporary carrier plate 111 of the first substrate 11 to form the composite-type micro-inductor 10. The first temporary carrier plate 111 can be removed by grinding, etching, or direct peeling, and there is no restriction herein.

Based on the above description, the present invention divides the composite-type micro-inductor 10 into the first substrate 11 serving as the magnetic core part and the second substrate 12 serving as the inductor coil part, and then combines the first substrate 11 and the second substrate 12. Therefore, according to different inductance value requirements, different types of magnetic cores and inductor coils with different numbers of turns can be combined. Through the flexible combination of various components, it is easy to design and manufacture micro-inductors. On the other hand, through the carrier board manufacturing process and molding process that based on electroplating, it will be possible to produce more miniaturized and thinner products, and to reduce volume of inductors.

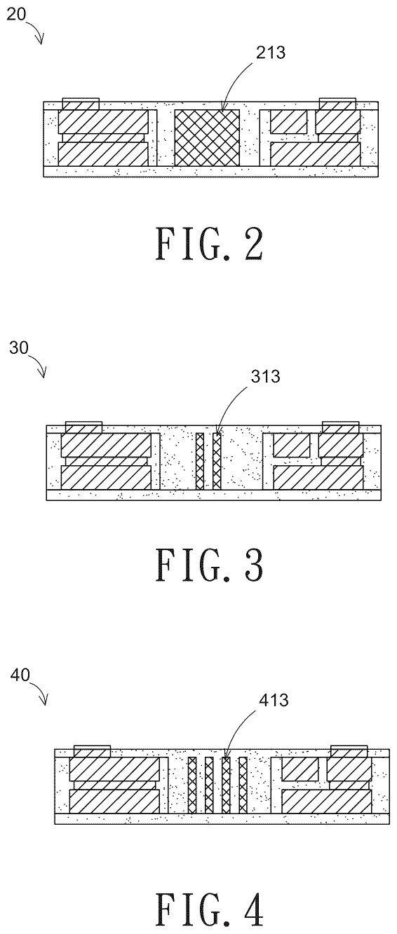

In addition to the columnar shape described in the above embodiment, the magnetic assembly 113 used as a magnetic core in the present invention can also have different shaped variations. In some embodiments as shown in FIG. 2, a magnetic assembly 213 of a composite-type micro-inductor 20 is in a shape of a block. In some embodiments as shown in FIG. 3, a magnetic assembly 313 of a composite-type micro-inductor 30 is in a shape of a sheet. In some embodiments as shown in FIG. 4, a magnetic assembly 413 of a composite-type micro-inductor 40 is in a shape of an array column.

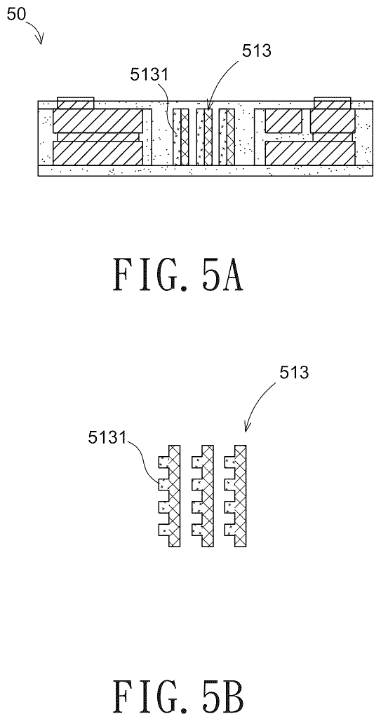

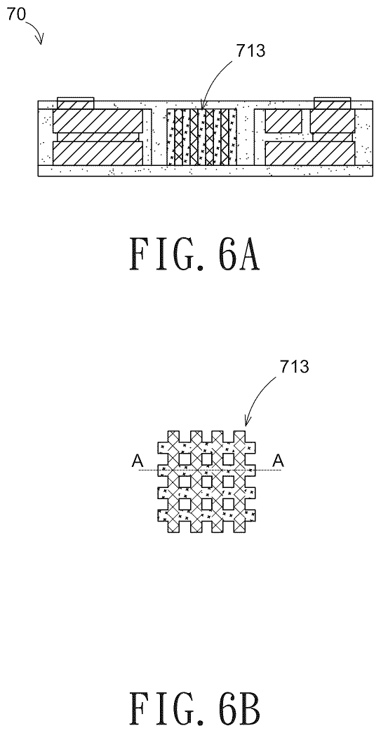

Please refer to FIGS. 5A and 5B. FIG. 5A is a schematic cross-sectional view of a composite-type micro-inductor 50 according to another embodiment, and FIG. 5B is a schematic top view of a magnetic assembly 513 of FIG. 5A. The magnetic assembly 513 of the composite-type micro-inductor 50 also has a plurality of convex parts 5131 on the sheet-like body to form a shape of a fin. Please refer to FIGS. 6A and 6B. FIG. 6A is a schematic cross-sectional view of a composite-type micro-inductor 70 according to another embodiment, and FIG. 6B is a schematic top view of a magnetic assembly 713 of FIG. 6A, where FIG. 6A is a cross-sectional view, taken along line A-A in FIG. 6B. The magnetic assembly 713 of the composite-type micro-inductor 70 is in a shape of a grid when viewed from above.

The above-mentioned magnetic assembly can help to reduce a loss of eddy currents, when designed in the form of the block, the sheet, the array column, the fin, or the grid, thereby reducing the attenuation amplitude of inductance value when operating at high frequencies. On the other hand, a thickness and a number of layers of the magnetic assembly can control the inductance value. Therefore, different first substrates and second substrates can be combined according to needs to produce the required inductors.

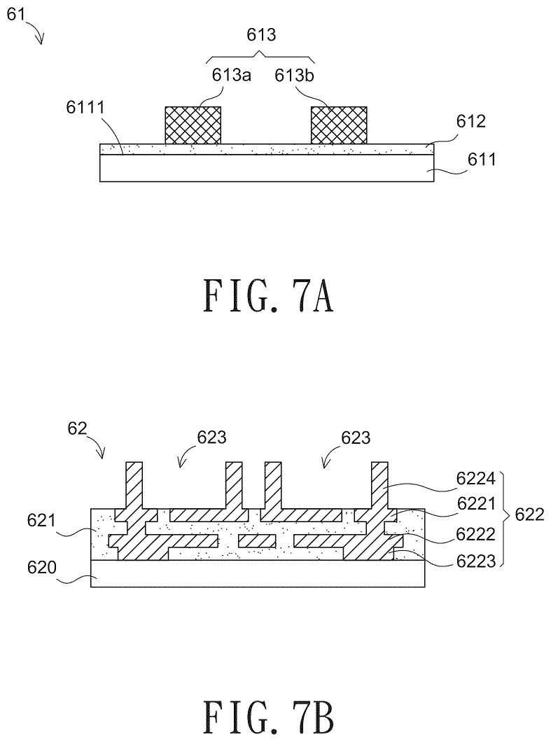

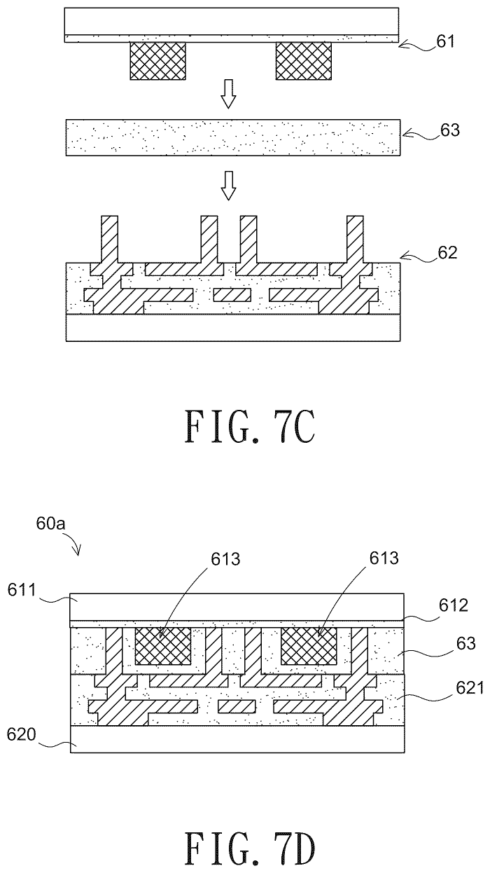

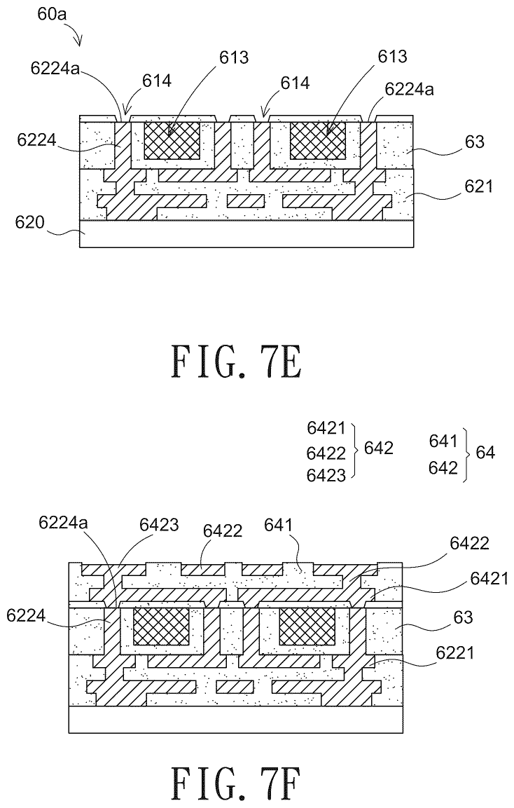

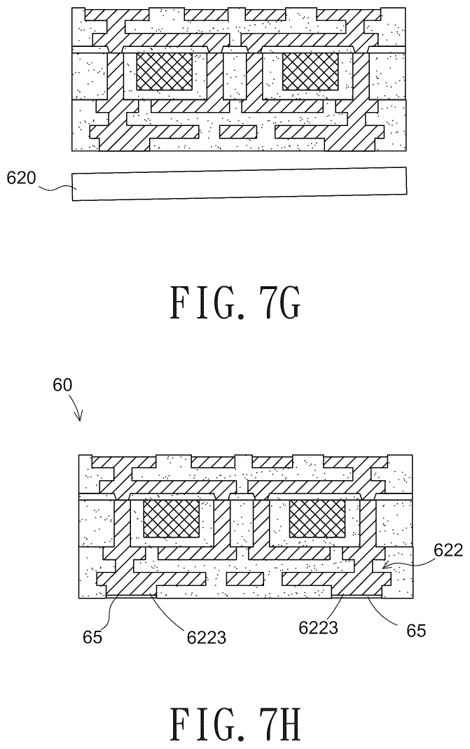

In addition, please refer to FIGS. 7A to 7H. FIGS. 7A to 7H illustrate the structural schematic diagram corresponding to a manufacturing method of a composite-type micro-inductor 60 according to a second preferred embodiment of the present invention. The manufacturing method of the composite-type micro-inductor 60 includes steps S11 to S18. It should be noted that the steps described in the present embodiment are not limited to their order, except for those specifically describing steps with a specific relationship of order.

As shown in FIG. 7A, step S11 is to provide a first substrate 61, which includes a first temporary carrier plate 611, a first dielectric layer 612, and a magnetic assembly 613. The first dielectric layer 612 is formed and covers on a surface 6111 of the first temporary carrier plate 611. The magnetic assembly 613 is disposed on the first dielectric layer 612. The magnetic assembly 613 in the present embodiment is an annular magnetic component. In the cross-sectional view of FIG. 7A, the magnetic assembly 613 appears to include two block-shaped magnetic blocks 613a and 613b, which are disposed on the first dielectric layer 612. In other embodiments, the magnetic assembly 613 can also be in a form of an annular plate or an annular array column. In addition, the first substrate 61 is similar to the first substrate 11 and can be manufactured through the carrier board manufacturing process, and no redundant detail is to be given herein.

As shown in FIG. 7B, step S12 is to provide a second substrate 62, which includes a second dielectric layer 621, a second patterned circuit layer 622, and a plurality of second openings 623. The second substrate 62 is a circuit build-up structure. A part of the second patterned circuit layer 622 is embedded in the second dielectric layer 621. The second patterned circuit layer 622 embedded in the second dielectric layer 621 includes a part of a second inductive circuit 6221, a second conductive circuit 6222, and a second electrode 6223. In addition, a part of the second patterned circuit layer 622 is exposed to the second dielectric layer 621 without being wrapped, and includes a part of a second inductive circuit 6224. Herein, the second inductive circuit 6224 that is not wrapped by the second dielectric layer 621 can be a conductive column.

As illustrated further herein, the second dielectric layer 621 and the second patterned circuit layer 622 can be formed layer by layer through the carrier board manufacturing process. For example, a second sub-dielectric layer is formed on a second temporary carrier plate 620. After a second patterned opening is formed on the second sub-dielectric layer, a second conductive metal is electroplated in the second patterned opening. Then, the above-mentioned steps of forming the second sub-dielectric layer, forming the second patterned opening, and electroplating the second conductive metal to form the second dielectric layer 621 and the second patterned circuit layer 622 in a manner of layer by layer are repeated. A second conductive metal system can be a conductive wire or a conductive column.

As shown in FIG. 7C, step S13 is to combine the first substrate 61, the second substrate 62, and an insulating film 63 to form a semi-finished inductor 60a as shown in FIG. 7D. The first substrate 61 and the second substrate 62 are disposed in a manner that the first temporary carrier plate 611 and the second temporary carrier plate 620 are away from each other, and the magnetic assembly 613 of the first substrate 61 is threaded through and disposed in an opening 623 of the second substrate 62. Then, the first substrate 61, the second substrate 62, and the insulating film 63 can be laminated through a compression molding or molding process to form the semi-finished inductor 60a.

As illustrated further herein, in the step S13, the second substrate 62 is used as a carrier, the insulating film 63 is stacked and covers on the second substrate 62, and the first substrate 61 is subsequently stacked and covers on the insulating film 63 and the second substrate 62 and then laminated together. In the present structure, the magnetic assembly 613 of the first substrate 61 is embedded in an area framed by the second inductive circuit 6224. In detail, a part of a conductive column-shaped area framed by the second inductive circuit 6224 can accommodate the magnetic assembly 613. On the other hand, the insulating film 63 is filled between the first dielectric layer 612 and the second dielectric layer 621. Further, the magnetic assembly 613 is embedded in the insulating film 63, and the first substrate 61 and the second substrate 62 combined as a whole. It is worth mentioning that a material of the insulating film 63 can also be a same dielectric material that uses in the first dielectric layer 612 or the second dielectric layer 621.

As shown in FIG. 7E, step S14 is to remove the first temporary carrier plate 611 to expose the surface 6121 of the first dielectric layer 612. Step S15 is to remove a part of the first dielectric layer 612 to form a plurality of blind holes 614 thereby exposing a part of a surface 6224a of the second inductive circuit 6224. In the present embodiment, the blind holes 614 can be completed by laser etching or chemical etching.

As shown in FIG. 7F, step S16 is to form a third substrate 64 on the first dielectric layer 612 by a build-up layer circuit process. The third substrate 64 is a layer including a third dielectric layer 641 and a third patterned circuit layer 642 that are formed upon the surface 6224a of an exposed part of the second inductive circuit 6224 of the second patterned circuit layer 622 and the insulating film 63. The third patterned circuit layer 642 is a plurality of layers and embeds in the third dielectric layer 641.

As illustrated further herein, the manufacturing process of the third patterned circuit layer 642 in the step S16 includes: forming a third sub-dielectric layer on the surface 6224a of the conductive column of the second inductive circuit 6224 and the first dielectric layer 612, forming a third patterned opening on the third sub-dielectric layer, and then forming a third conductive metal in the third patterned opening. Then, the above steps are repeated several times to form the third patterned circuit layer 642 and the third dielectric layer 641. Herein, the third dielectric layer 641 is constituted of the stacked third sub-dielectric layers.

It is worth mentioning that the third patterned circuit layer 642 includes a part of a third inductive circuit 6421, a third conductive circuit 6422, and a third electrode 6423. In the present embodiment, a part of the second inductive circuit 6221, a part of the second inductive circuit 6224 in a shape of a conductive column, and a part of the third inductive circuit 6421 can form a complete inductor circuit surrounding the magnetic assembly 613 in a form of an annular solenoid coil. In addition, a part of a surface of the third patterned circuit layer 642 is exposed on a surface of an upper side of the third dielectric layer 641 that serves as the third electrode 6423.

As shown in FIG. 7G, step S17 is to remove the second temporary carrier plate 620. Then as shown in FIG. 7H, step S18 is to form a bonding protective layer 65 on an exposed part of the second electrode 6223 of the second patterned circuit layer 622. In the present embodiment, the bonding protective layer 65 can protect the electrode terminals from oxidative deterioration, and can also have the function of being easily combined with other metals. Accordingly, the composite-type micro-inductor 60, such as the annular solenoid coil, is formed.

It is worth mentioning that before forming the bonding protective layer 65, the second electrode 6223 can also be thinned by a thinning manufacturing process, such as grinding or etching, so that a surface of the second electrode 6223 is slightly smaller than a surface of the second patterned circuit layer 622, and after thinning manufacturing process, the bonding protective layer 65 is formed.

A manufacturing method of a composite-type micro-inductor according to a third preferred embodiment of the present invention is similar to the composite-type micro-inductor 60 according to the second embodiment. The main difference lies in a part providing a second substrate. Therefore, only the differences will be described hereinafter, and same components will also be referenced with the component symbols of the second embodiment.

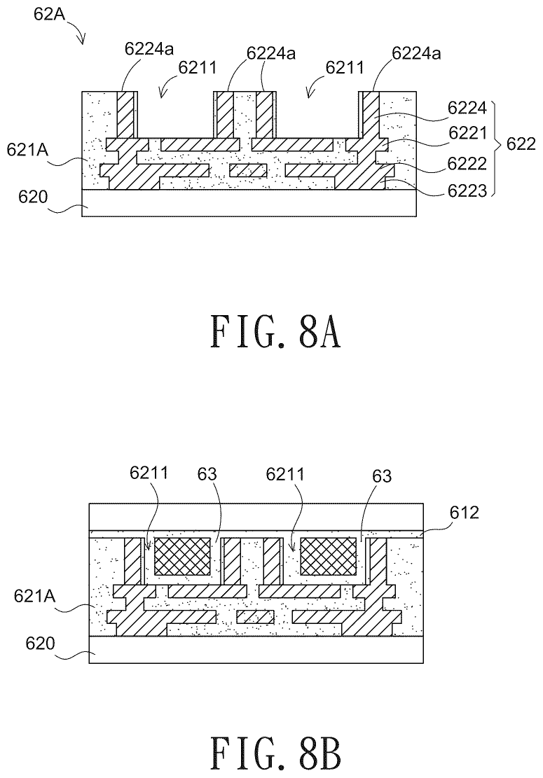

Referring to FIG. 8A, a second substrate 62A provided in the present embodiment has the second temporary carrier plate 620, a second dielectric layer 621A, and the second patterned circuit layer 622. The difference from the second embodiment is that a part of the second inductive circuit 6221, the second conductive circuit 6222, the second electrode 6223 and the part of the second inductive circuit 6224 of the second patterned circuit layer 622 are embedded in the second dielectric layer 621A, and only the part of the surface 6224a of the second inductive circuit 6224 is exposed. Accordingly, the second dielectric layer 621A has an opening 6211, and an area framed by the second inductive circuits 6221 and 6224 substantially overlaps with the opening 6211.

In addition, as shown in FIG. 8B, another difference is that the insulating film 63 is filled between the first dielectric layer 612 and the second dielectric layer 621A and in the opening 6211. Further, the magnetic assembly 613 is embedded in the insulating film 63, and the first substrate 61 and the second substrate 62A combined as a whole.

In addition to the above differences, the manufacturing method of the composite-type micro-inductor in the third embodiment is generally the same as the manufacturing method of the composite-type micro-inductor 60 in the second embodiment, and no redundant detail is to be given herein.

In summary, the manufacturing method of the composite-type micro-inductor of the present invention is to separately manufacture the first substrate as the magnetic core part of the inductor and the second substrate as the inductor coil part, and then combine the first substrate and the second substrate to form the composite-type micro-inductor. Therefore, according to different inductance value requirements, different magnetic core parts and inductor coil parts can be flexibly selected for combination. In addition, the composite-type micro-inductor manufactured through the carrier board manufacturing process and the molding process can further miniaturize the inductor. On the other hand, the manufacturing method of the composite-type micro-inductor of the present invention can be applied to various types of micro-inductors such as the multi-layer planar spiral coil, the solenoid coil, or the annular solenoid coil.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A manufacturing method of a composite-type micro-inductor, the manufacturing method comprising:
providing a first substrate, having a first temporary carrier plate, a first dielectric layer, and a magnetic assembly, wherein the first dielectric layer is formed on a surface of the first temporary carrier plate, and the magnetic assembly is disposed on the first dielectric layer;
providing a second substrate, having a second dielectric layer, a second patterned circuit layer stacked in a plurality of layers, and an opening penetrating through the second dielectric layer, wherein at least a part of the second patterned circuit layer is embedded in the second dielectric layer, a part of the second patterned circuit layer constitutes an inductor coil, a part of the second patterned circuit layer constitutes a conductive circuit and/or a plurality of electrodes, and a central area of the inductor coil overlaps with the opening;
using the first substrate as a carrier and disposing the second substrate on the first substrate, wherein the magnetic assembly of the first substrate is threaded through and disposed in the opening of the second substrate;
forming a third dielectric layer to cover the first substrate and the second substrate filling the opening with the third dielectric layer, the magnetic assembly is embedded in the third dielectric layer, and the first substrate and the second substrate combined as a whole;
performing a leveling process to remove a part of the third dielectric layer, thereby exposing a part of a surface of the second patterned circuit layer; and
removing the first temporary carrier plate of the first substrate to form an inductor structure.

2. The manufacturing method of the composite-type micro-inductor according to claim 1, wherein the magnetic assembly comprises at least one magnetic component in a form of a block, an array column, a sheet, a fin, or a grid.

3. The manufacturing method of the composite-type micro-inductor according to claim 1, wherein the inductor coil comprises a solenoid coil, or a multi-layer planar spiral coil.

4. A manufacturing method of a composite-type micro-inductor, the manufacturing method comprising:
providing a first substrate, having a first temporary carrier plate, a first dielectric layer, and a magnetic assembly, wherein the first dielectric layer is formed on a surface of the first temporary carrier plate, and the magnetic assembly is disposed on the first dielectric layer;
providing a second substrate, having a second temporary carrier plate, a second dielectric layer disposing on the second temporary carrier plate, and a second patterned circuit layer stacked in a plurality of layers, wherein a part of a structure of the second patterned circuit layer is embedded in the second dielectric layer, a part of the second patterned circuit layer constitutes a second conductive circuit and/or a plurality of second electrodes, a part of the second patterned circuit layer constitutes a second inductive circuit, and a part of the second inductive circuit is not wrapped by the second dielectric layer;
using the second substrate as a carrier and sequentially stacking and covering an insulating film and the first substrate onto the second substrate for lamination, wherein the magnetic assembly of the first substrate is embedded in an area framed by the second inductive circuit, the magnetic assembly and the second inductive circuit do not electrically connect to each other, the insulating film is filled between the first dielectric layer and the second dielectric layer, the magnetic assembly is embedded in the insulating film, and the first substrate and the second substrate combined as a whole;
removing the first temporary carrier plate to expose a surface of the first dielectric layer;
removing a part of the first dielectric layer to form a plurality of blind holes, thereby exposing a part of a surface of the second patterned circuit layer;
forming a third substrate on the first dielectric layer by a build-up layer circuit process, wherein the third substrate comprises a third dielectric layer and a third patterned circuit layer stacked in a plurality of layers and embedded in the third dielectric layer, a part of the third patterned circuit layer constitutes a third inductive circuit electrically connected to the second patterned circuit layer, the third patterned circuit layer combines with the second inductive circuit of the second patterned circuit layer to constitute a complete inductor coil, a part of the third patterned circuit layer constitutes a third conductive circuit and/or a plurality of third electrodes, and a part of a surface of the third patterned circuit layer is exposed on a surface of an upper side of the third dielectric layer; and
removing the second temporary carrier plate of the second substrate to form an inductor structure.

5. The manufacturing method of the composite-type micro-inductor according to claim 4, wherein the second inductive circuit comprises a plurality of conductive columns, the conductive columns are not wrapped by the second dielectric layer, and an area framed by the conductive columns can accommodate the magnetic assembly.

6. The manufacturing method of the composite-type micro-inductor according to claim 4, wherein the magnetic assembly comprises at least one magnetic component in a form of a block, an array column, a sheet, a fin, or a grid.

7. The manufacturing method of the composite-type micro-inductor according to claim 4, wherein the inductor coil is an annular solenoid coil.

8. A manufacturing method of a composite-type micro-inductor, the manufacturing method comprising:
providing a first substrate, having a first temporary carrier plate, a first dielectric layer, and a magnetic assembly, wherein the first dielectric layer is formed on a surface of the first temporary carrier plate, and the magnetic assembly is disposed on the first dielectric layer;
providing a second substrate, having a second temporary carrier plate, a second dielectric layer having an opening and disposing on the second temporary carrier plate, and a second patterned circuit layer stacked in a plurality of layers, wherein a part of a structure of the second patterned circuit layer is embedded in the second dielectric layer, a part of the second patterned circuit layer constitutes a second conductive circuit and/or a plurality of second electrodes, a part of the second patterned circuit layer constitutes a second inductive circuit, and an area that frames by the second inductive circuit overlaps with the opening;
using the second substrate as a carrier and sequentially stacking and covering an insulating film and the first substrate onto the second substrate for lamination, wherein the magnetic assembly of the first substrate is embedded in the opening and does not electrically connect to the second inductive circuit, the insulating film is filled between the first dielectric layer and the second dielectric layer and in the opening, the magnetic assembly is embedded in the insulating film, and the first substrate and the second substrate combined as a whole;
removing the first temporary carrier plate to expose a surface of the first dielectric layer;
removing a part of the first dielectric layer to form a plurality of blind holes, thereby exposing a part of a surface of the second inductive circuit;
forming a third substrate on the first dielectric layer by a build-up layer circuit process, wherein the third substrate comprises a third dielectric layer and a third patterned circuit layer stacked in a plurality of layers and embedded in the third dielectric layer, a part of the third patterned circuit layer constitutes a third inductive circuit electrically connected to the second inductive circuit, the third patterned circuit layer combines with the second inductive circuit to constitute a complete inductor coil, a part of the third patterned circuit layer constitutes a third conductive circuit and/or a plurality of third electrodes, and a part of a surface of the third patterned circuit layer is exposed on a surface of an upper side of the third dielectric layer; and
removing the second temporary carrier plate of the second substrate to form an inductor structure.

9. The manufacturing method of the composite-type micro-inductor according to claim 8, wherein the magnetic assembly comprises at least one magnetic component in a form of a block, an array column, a sheet, a fin, or a grid.

10. The manufacturing method of the composite-type micro-inductor according to claim 8, wherein the inductor coil comprises an annular solenoid coil, a solenoid coil, or a multi-layer planar spiral coil.
